(19) United States
(12) Patent Application Publication
(10) Pub. No.: US 2005/0193956 A1
(43) Pub. Date: Sep. 8, 2005

(54) Synthetic ocean salt

(76) Inventors: Glen S. Axelrod, Colts Neck, NJ (US); Virendra Tuli, Carson, CA (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/062,885

(22) Filed: Feb. 22, 2005

Related U.S. Application Data
(60) Provisional application No. 60/546,578, filed on Feb. 20, 2004.

(51) Int. Cl. C11D 1/00

(52) U.S. Cl. 119/231

(57) ABSTRACT

The present invention is directed at a marine salt composition, suitable for simulating the marine environment, which composition comprises sodium chloride, magnesium chloride, anhydrous sodium sulfate, calcium chloride, potassium chloride, sodium bicarbonate and boric acid. The composition is substantially free of nitrate, nitrite, ammonia and phosphate ions. The magnesium chloride is present at 15-40 mesh and the calcium chloride is present at 20-50 mesh.

### CROSS-REFERENCE TO RELATED APPLICATIONS

The present application claims the benefit of the filing date of U.S. Provisional Application Ser. No. 60/546,578 filed Feb. 20, 2004, the teachings of which are incorporated herein by reference.

The present invention relates to the production of a composition of a sea salt mixture, suitable to reproduce the physical and chemical qualities of natural sea water. In one particular embodiment the present invention relates to a solid sea salt mixture which more rapidly dissolves and which is more efficient in its dissolution qualities when combined with water to create the marine environment, suitable for the maintenance, growth and support of marine life.

### BACKGROUND OF THE INVENTION

A number of disclosures, over the years, have sought to provide the most efficient method for simulating the marine environment. For example, in U.S. Pat. No. 3,025,831, entitled “Lobster Tank With Artificial Ocean Water”, it was disclosed that there was a need to develop an artificial ocean water conductive to the life of the lobster or any other salt water fish. Along such lines, it was disclosed that the following components may be utilized to achieve the formation of artificial ocean water: NaCl, MgCl₂, MgSO₄, KCl, CaCl₂, NaHCO₃, NaBr, NaHSO₄, and 3 drops of iodine solution.

In addition, attention is directed to U.S. Pat. No. 5,485,808 entitled “Synthetic Sear Water Solution Kit And Method of Manufacture”, which discloses a concentrated synthetic sea water solution, which upon dilution with fresh water, is said to produce a high purity synthetic sea water. The liquid mixture is composed of two separate and equal volume portions, each portion containing a percentage of specific major and minor ions. The solution may also contain essential trace elements. The solution is also said to be extremely pure, being specifically treated to remove harmful, non-essential heavy metals.

In addition, various commercial reports exist regarding synthetic sea salt mixtures. For example, a synthetic sea salt sold under the trademark Coral Sea® is widely available, and described as a single phase synthetic sea salt. The specification for the Coral Sea® product indicates that it contains the following elemental, vitamin or ion distribution: Cl—, Na+, Mg++, SO₄——, S₂O₃——, Ca++, K+, Br, C, Sr++, BO₃——, F, NO₃, PO₄, Mn++, SiO₃, Ba++, MoO₄——, Li+, Al———, Fe+++, Thaimine (vitamin B₁), Iodine (as I—), Vanadium as VO——, Cobalt as Co++, Cu++, Biotin and Cyanocobalamin (vitamin B₁₂). It is also noted that the solid sea salt mixture should be used as soon as possible after it is opened from any sealed packaging.

In addition, to the above, a number of other synthetic sea salt mixtures are on the market. These include, for example, products sold under the following trademarks: Instant Ocean®, Tropic Marine®, Kent Sea Salt®, Oceanic Sea Salt®, Reef Crystals® and Red Sea Salt®. Each manufacturer, not surprisingly, advances various reasons as to why they might consider their particular mixture to provide the optimum marine environment for the aquarium hobby.

In spite of the above, a need continues for a marine sea salt mixture which would continue to provide an optimum marine environment, which would be inexpensive to manufacture, rapidly dissolving, and convenient for use by consumers. Accordingly, it is an object of this invention to provide an improved synthetic sea salt mixture which achieves such goals, among others, as more fully disclosed herein.

### SUMMARY OF THE INVENTION

The present invention is directed at a marine salt composition, suitable for simulating the marine environment, which composition comprises the following:

| | | |
|---|---|---|
| Sodium Chloride | 50-55% | (wt) |
| Magnesium Chloride | 30-32% | (wt) |
| Anhydrous Sodium Sulfate | 7-10% | (wt) |
| Calcium Chloride | 2-4% | (wt) |
| Potassium Chloride | 2-4% | (wt) |
| Sodium Bicarbonate | 0.1-1% | (wt) |
| Boric Acid | 0.001-0.010% | (wt) |

Preferably, all of the above ingredients are prepared and made to be free of nitrate, nitrite, ammonia and phosphate. The magnesium chloride and calcium chloride are also preferably ground before introduction to the above mixture. Subsequent to grinding, the magnesium chloride is preferably 15-40 mesh, more preferably about 20-30 mesh. The calcium chloride is also preferably 20-50 mesh, more preferably 30-40 mesh.

Furthermore, as the ingredients are substantially free of nitrate, nitrite, ammonia and phosphate, it is worth pointing out that, e.g., in the case of the sodium chloride, a so-called relatively high-grade sodium chloride may be selected, that is indeed substantially free of nitrate, nitrite, ammonia and phosphate. Such grade of sodium chloride may be obtained from North American Salt Company, Kansas. Such sodium chloride is one in which anti-caking agents, which are typically calcium phosphates, are eliminated. Similarly, the magnesium chloride herein may be obtained from Dead Sea Works, Israel.

In addition, it should be noted that in a most preferred embodiment, the sodium chloride is present at a level of about 53% by weight, the magnesium chloride is present at about 31.7% by weight, the anhydrous sodium sulfate is present at about 8.9% by weight, the calcium chloride is 94-96% pure and is present at a level of about 3.5% by weight, the potassium chloride is present at about 2.2% by weight, the sodium bicarbonate is present at about 0.6% by weight, and the boric acid is present at about 0.005% by weight.

In accordance with the present invention it has been found that the above sea salt mixture provides a more rapidly dissolving, and equal if not better marine environment than those commercial sea salt mixtures that typically contain more complex and expensive ingredients, and which require more expensive and complex manufacturing facilities. Furthermore, the solubility, pH, specific gravity, turbidity, and levels of calcium and magnesium provided herein are all within the range of requirements of marine sea water, and accordingly, facilitate the formation of a marine environment suitable to maintain and support any and all types of marine organisms for an indefinite period of time. Accordingly, the sea salt formulation herein does not contain an excess of any particular element, is easily mixed, is not excessively hygroscopic, does not form insoluble precipitates, is not required to age for any period of time before addition to the marine environment, and can be directly added to the aquarium.

1. A synthetic sea salt formulation comprising:

| | | |
|---|---|---|
| sodium chloride | 50-55% | (wt) |
| magnesium chloride | 30-32% | (wt) |
| anhydrous sodium sulfate | 7-10% | (wt) |
| calcium chloride | 2-4% | (wt) |
| potassium chloride | 2-4% | (wt) |
| sodium bicarbonate | 0.1-1% | (wt) |
| boric acid | 0.001-0.010% | (wt). |

2. The synthetic sea salt formulation of claim 1 wherein the sodium chloride is present at a level of about 53% (wt), the magnesium chloride is present at about 31.7% (wt), the anhydrous sodium sulfate is present at about 8.9% (wt), the calcium chloride is 94-96% pure and is present at a level of about 3.5% (wt), the potassium chloride is present at about 2.2% (wt), the sodium bicarbonate is present at about 0.6% (wt), and the boric acid is present at about 0.005% (wt).

3. The synthetic sea salt formulation of claim 1, wherein said magnesium chloride is about 15-40 mesh, and said calcium chloride is at about 20-50 mesh.

4. The synthetic sea salt formulation of claim 3, wherein said magnesium chloride is present at about 20-30 mesh, and said calcium chloride is present at about 30-40 mesh.

5. The synthetic sea salt formulation of claim 1 wherein said sea salt formulation is substantially free of nitrate, nitrite, ammonia and phosphate.

6. The synthetic sea salt formulation of claim 3 wherein said sea salt formulation is substantially free of nitrate, nitrite, ammonia and phosphate.

7. A method of forming a sea salt formulation comprising:
(a) supplying magnesium chloride and grinding to about a 15-40 mesh;
(b) supplying calcium chloride and grinding to about a 20-50 mesh;
(c) supplying sodium chloride, anhydrous sodium sulfate, potassium chloride, sodium bicarbonate and boric acid;
(d) combining said magnesium chloride of about 15-40 mesh and calcium chloride of about 20-50 mesh with the sodium chloride, anhydrous sodium sulfate, potassium chloride, sodium bicarbonate and boric acid to provide a sea salt with the following:

| | | |
|---|---|---|
| sodium chloride | 50-55% | (wt) |
| magnesium chloride | 30-32% | (wt) |
| anhydrous sodium sulfate | 7-10% | (wt) |
| calcium chloride | 2-4% | (wt) |
| potassium chloride | 2-4% | (wt) |
| sodium bicarbonate | 0.1-1% | (wt) |
| boric acid | 0.001-0.010% | (wt) |

wherein the sea salt is substantially free of nitrate, nitrite, ammonia and phosphate.

8. The method of claim 7 further including the step of adding said sea salt formulation to water to provide a synthetic sea water.

9. A synthetic sea water kit comprising:

| | | |
|---|---|---|
| sodium chloride | 50-55% | (wt) |
| magnesium chloride | 30-32% | (wt) |
| anhydrous sodium sulfate | 7-10% | (wt) |
| calcium chloride | 2-4% | (wt) |
| potassium chloride | 2-4% | (wt) |
| sodium bicarbonate | 0.1-1% | (wt) |
| boric acid | 0.001-0.010% | (wt) |

wherein said magnesium chloride is about 15-40 mesh, said calcium chloride is about 20-50 mesh, and where the sodium chloride, magnesium chloride, anhydrous sodium sulfate, calcium chloride, potassium chloride, sodium bicarbonate and boric acid are substantially free of nitrate, nitrite, ammonia and phosphate ions.
